(19) United States
(12) Patent Application Publication
(10) Pub. No.: US 2014/0344860 A1
(43) Pub. Date: Nov. 20, 2014

(54) BROADCAST IMAGE OUTPUT DEVICE, BROADCAST IMAGE OUTPUT METHOD, AND TELEVISON

(71) Applicant: Panasonic Corporation, Osaka (JP)

(72) Inventors: Shunsuke TANAKA, Osaka (JP); Koumei KUBOTA, Kyoto (JP); Tatsuo HIROSE, Osaka (JP)

(21) Appl. No.: 14/446,889

(22) Filed: Jul. 30, 2014

Related U.S. Application Data
(62) Division of application No. 13/928,957, filed on Jun. 27, 2013.

(30) Foreign Application Priority Data
Dec. 26, 2012 (JP) 2012-283644

(51) Int. Cl. H04N 21/485

(52) U.S. Cl. 725/44

(57) ABSTRACT

A broadcast image output device includes: a reception unit that receives a broadcast; an output unit that outputs a plurality of home screens in each of which a broadcast image relating to the broadcast received by the reception unit or an app image is allocatable to each section of a display area, the broadcast image and the app image being selectable by user operation; and a control unit that selects one of the home screens in accordance with preset setting information to cause the output unit to output the selected home screen as an initial screen that is ready to accept the user operation and appears after the broadcast image output device is turned on.

### CROSS REFERENCE TO RELATED APPLICATION

The present application is based on and claims priority of Japanese Patent Application No. 2012-283644 filed on Dec. 26, 2012. The entire disclosure of the above-identified application, including the specification, drawings and claims is incorporated herein by reference in its entirety.

### FIELD

The present disclosure relates to broadcast image output devices and televisions which can output broadcast images.

### BACKGROUND

Patent Literature 1 discloses an information display device for displaying information on a television. When the power is turned on, this information display device displays, as an initial screen, the channel last viewed before the power is turned off, i.e., the last channel.

Moreover, after displaying the initial screen, this information display device displays a graphical user interface (GUI) screen showing more than one icon in response to user operation. This allows this information display device to perform processing such as displaying data according to icons selected by a user.

### CITATION LIST

### Patent Literature

[PTL 1] Japanese Patent No. 4052802

### SUMMARY

### Technical Problem

The present disclosure provides broadcast image output devices which can efficiently perform processing relating to the display of an initial screen suitable for a user.

### Solution to Problem

A broadcast image output device in the present disclosure includes: a reception unit that receives a broadcast; an output unit that outputs a plurality of home screens in each of which a broadcast image relating to the broadcast received by the reception unit or an image other than the broadcast image is allocatable to each section of a display area, the broadcast image and the image other than the broadcast image being selectable by user operation; and a control unit that selects one of the home screens in accordance with preset setting information to cause the output unit to output the selected home screen as an initial screen that is ready to accept the user operation and appears after the broadcast image output device is turned on.

### Advantageous Effects

Broadcast image output device in the present disclosure can efficiently perform processing relating to the display of an initial screen suitable for a user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an external view of a television and a remote control in the embodiment.

FIG. 2 is a block diagram illustrating a basic functional configuration of a television in the embodiment.

FIG. 3 is a flowchart illustrating the steps of basic operation of a broadcast image output device in the embodiment.

FIG. 4 illustrates an example of a basic configuration of a home screen in the embodiment.

FIG. 5A illustrates a first example of a home screen in the embodiment.

FIG. 5B illustrates a second example of a home screen in the embodiment.

FIG. 5C illustrates a third example of a home screen in the embodiment.

FIG. 6 illustrates a state in which a broadcast image is selected in a home screen in the embodiment.

FIG. 7A illustrates a state in which a broadcast image is displayed on the full screen of a television in the embodiment.

FIG. 7B illustrates a state in which an app setting screen is displayed on the full screen of a television in the embodiment.

FIG. 8 is a first figure illustrating an example of the transition of the display screen of a television in the embodiment.

FIG. 9 illustrates an example of a home switching screen in the embodiment.

FIG. 10 is a second figure illustrating an example of the transition of the display screen of a television in the embodiment.

FIG. 11 illustrates an example of displaying buttons for the various settings of a home screen in the embodiment, for example.

FIG. 12 illustrates an example of options for an initial screen in the embodiment.

FIG. 13 illustrates a first example of an app edit screen in the embodiment.

FIG. 14 illustrates a second example of an app edit screen in the embodiment.

FIG. 15 illustrates an example of a template selection screen in the embodiment.

FIG. 16 is a figure to explain face recognition in the embodiment.

FIG. 17 is a block diagram illustrating a basic functional configuration of a television having a face recognition function in the embodiment.

FIG. 18 illustrates an example of the basic hardware configuration of a television in the embodiment.

FIG. 19 illustrates a basic functional configuration of a television having a function for changing a home screen to be displayed as an initial screen according to time.

### DESCRIPTION OF EMBODIMENTS The following details embodiments with reference to drawings.

However, too detailed explanation may be omitted. For example, the detailed explanation of a well-known matter or overlapping explanation for a substantially the same configuration may be omitted. This is to avoid unnecessarily redundant explanation in the following, and allow those skilled in the art to easily understand.

It should be noted that inventors et al. provide the appended drawings and the following explanation to allow those skilled in the art to sufficiently understand the present disclosure. However, these are not intended to limit the subject matter recited in Claims. Moreover, the drawings are schematic diagrams and are not necessarily exactly-illustrated drawings.

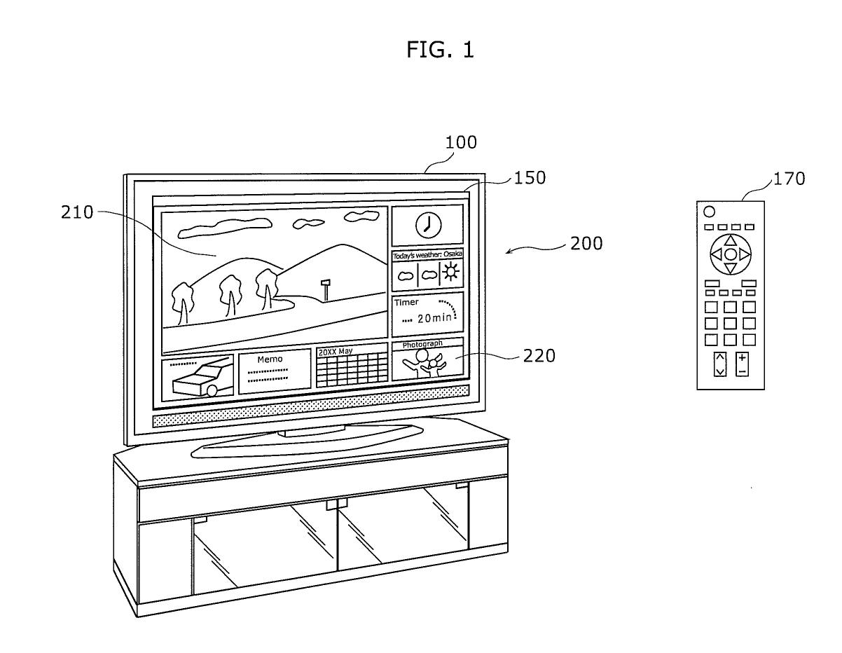

### Embodiment

[1-1. Configuration]FIG. 1 is an external view of a television 100 and a remote control 170 in the embodiment.

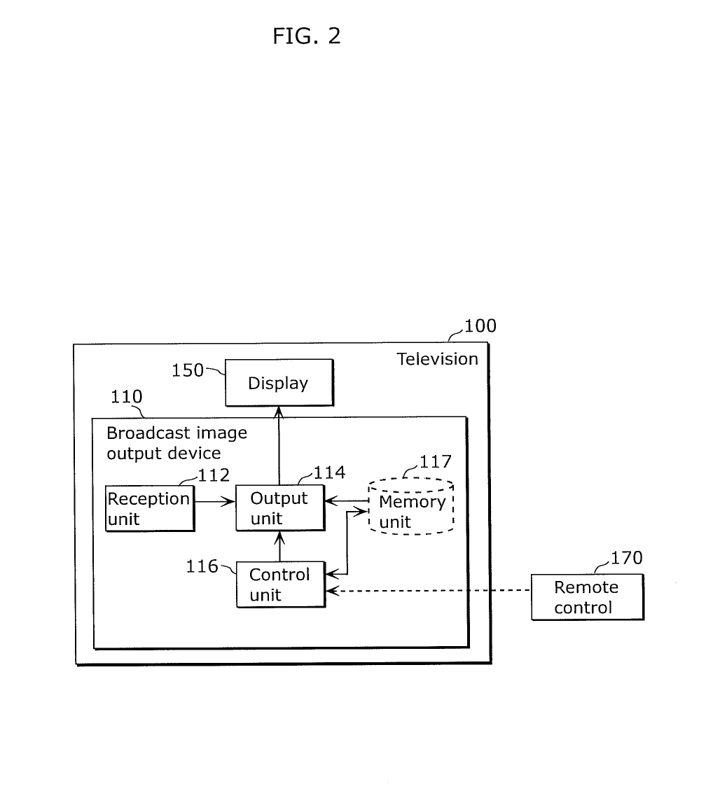

FIG. 2 is a block diagram illustrating a basic functional configuration of a television 100 in the embodiment.

As shown in FIGS. 1 and 2, the television 100 in the embodiment includes a broadcast image output device 110 and a display 150.

The television 100 can perform operations such as switching channels in accordance with signals from a remote control (or remote controller) 170 operated by a user.

Specifically, the remote control 170 has more than one key, and transmits signals indicating instructions according to keys depressed by the user to the television 100 by infrared rays. It should be noted that there is no particular limitation for a method of communicating between the remote control 170 and the television 100. For example, interactive communication between the remote control 170 and the television 100 may be performed by radio communication such as Bluetooth (a registered trademark).

Moreover, other than the functional block shown in FIG. 2, the television 100 includes structural elements such as a speaker which a television receiver should have. However, to clearly explain the content of the present disclosure, figures and explanations for these other structural elements are omitted here.

As shown in FIG. 2, the broadcast image output device 110 includes a reception unit 112, an output unit 114, a control unit 116, and a memory unit 117.

The reception unit 112 receives a broadcast received by a tuner (not shown in FIG. 2) of the television 100. The broadcast is a ground-wave broadcast, a satellite broadcast, a cable broadcast, or an Internet broadcast, for example. It should be noted that the reception unit 112 may function as the tuner.

The output unit 114 can output each of home screens 200. The outputted home screen 200 is displayed on the display 150.

For example as shown in FIG. 1, in each home screen 200, a broadcast image 210 relating to a broadcast received by the reception unit 112 or an image other than the broadcast image 210 is allocated to each section of a display area.

In the present embodiment, a playback video (moving images) of a broadcast received by the reception unit 112 is displayed on the home screen 200 as the broadcast image 210.

Each of images other than the broadcast image 210 is an app image 220 in the present embodiment. The app image 220 is, for example, an image associated with an application program (hereinafter also referred to as “app(s)”) executable by the broadcast image output device 110.

That is, the app image 220 is an image displayed by executing an app, an icon for activating an app, an icon corresponding to data processed by an app, or an icon corresponding to a predetermined website (web clip icon), for example.

For example, in the home screen 200 shown in FIG. 1, one relatively large broadcast image 210 and seven app images 220 are allocated.

It should be noted that the app images 220 and apps respectively corresponding to these app images 220 are stored in the memory unit 117, for example. Each app is read and executed by the control unit 116.

Moreover, an application program for displaying the broadcast image 210 is also stored in the memory unit 117. Processing such as the display and scaling of the broadcast image 210 is performed by the control unit 116 executing the application program.

Moreover, each of these broadcast images 210 and the app images 220 can be selected by user operation (operation with remote control 170 in the present embodiment).

For example, when the broadcast image 210 is selected and the select key of the remote control 170 is depressed, the broadcast image 210 is enlarged, and is displayed in the entire display area of the display 150, for example. That is, the broadcast image 210 is displayed on the full screen.

Moreover, when the app image 220 is selected and the select key of the remote control 170 is depressed, an app associated with the app image 220 is executed, for example, and an image showing a processing result of the app or the like is displayed on the full screen.

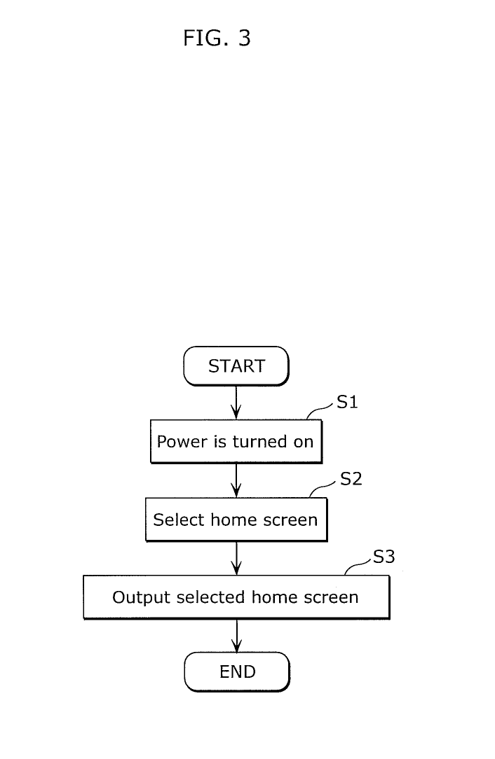

The operation of the broadcast image output device 110 and the home screens 200 will be detailed later with reference to FIGS. 3 to 15.

The control unit 116 selects one of the home screens 200 in accordance with preset setting information. Furthermore, the control unit 116 causes the output unit 114 to output the selected home screen 200 as an initial screen that is ready to accept user operation and appears after the broadcast image output device 110 is turned on.

The setting information referred to by control unit 116 to select one of the home screens 200 is stored in the memory unit 117, for example.

It should be noted that the control unit 116 is, for example, realized by a processor such as a central processing unit (CPU).

The memory unit 117 is a memory unit for storing various information such as the setting information. It should be noted that the broadcast image output device 110 does not have to include the memory unit 117. For example, a hard disk drive (HDD) or a semiconductor memory such as a flash memory which is outside of the broadcast image output device 110 may be used as the memory unit 117.

Moreover, a memory such as a random access memory (RAM) provided inside or outside of the broadcast image output device 110 may be used as the memory unit 117.

Thus, the television 100 in the present embodiment includes the broadcast image output device 110, and the broadcast image output device 110 outputs one of the home screens 200 as an initial screen.

That is, simply put, when the television 100 is turned on, one of the home screens 200 of different kinds is displayed as the initial screen.

It should be noted that “home screens 200 of different kinds” mean that the home screens 200 are different from each other in the kinds, layout, the number, and others of displayed images.

### [1-2. Basic Operation]

The following describes the operation of the broadcast image output device 110 in the embodiment with reference to FIG. 3.

FIG. 3 is a flowchart illustrating the steps of the basic operation of the broadcast image output device 110 in the embodiment.

When the broadcast image output device 110 is turned on (S1), the control unit 116 selects one of the home screens 200 which is indicated by the setting information (S2).

The output unit 114 outputs the home screen 200 selected by the control unit 116 in accordance with the control by control unit 116 (S3).

That is, the control unit 116 causes the output unit 114 to output the home screen 200 selected from a plurality of home screens 200, as an initial screen after the power is turned on.

Specifically, the broadcast image output device 110 is turned on by a user turning on the television 100. As a result, the home screen 200 selected by the control unit 116 is displayed on the display 150.

### [1-3. Home Screen]

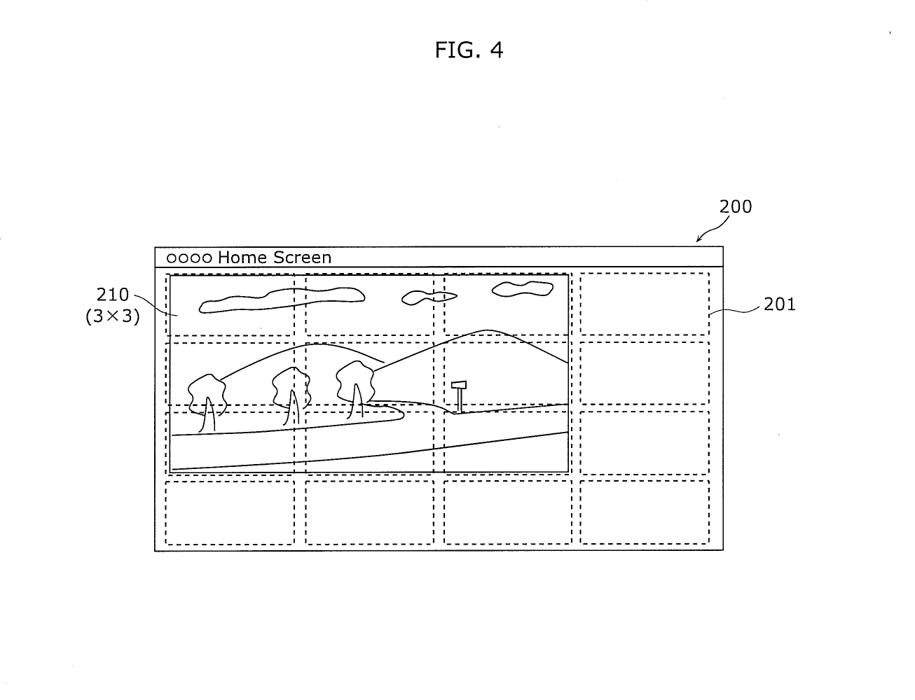

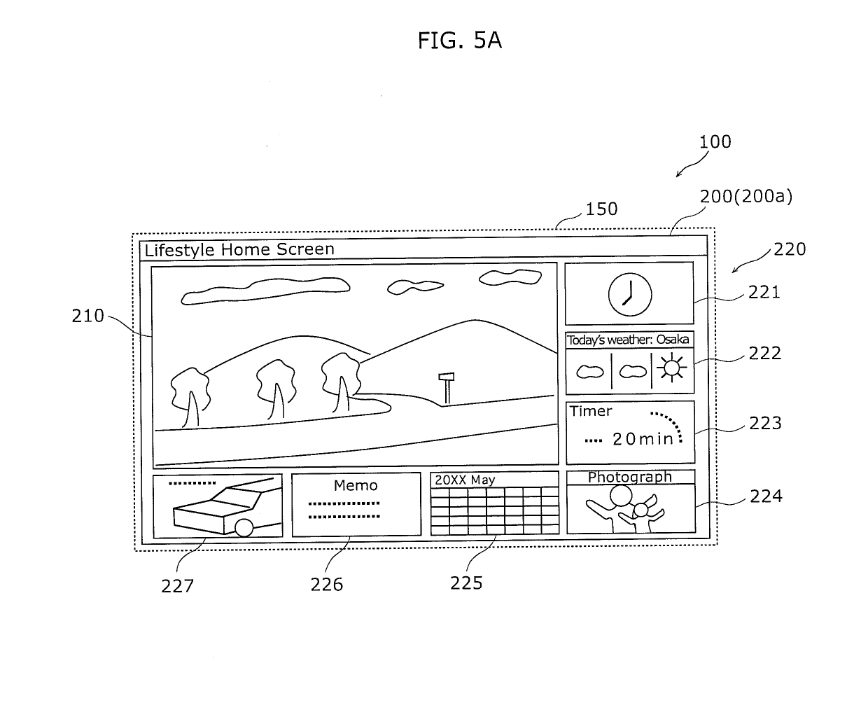

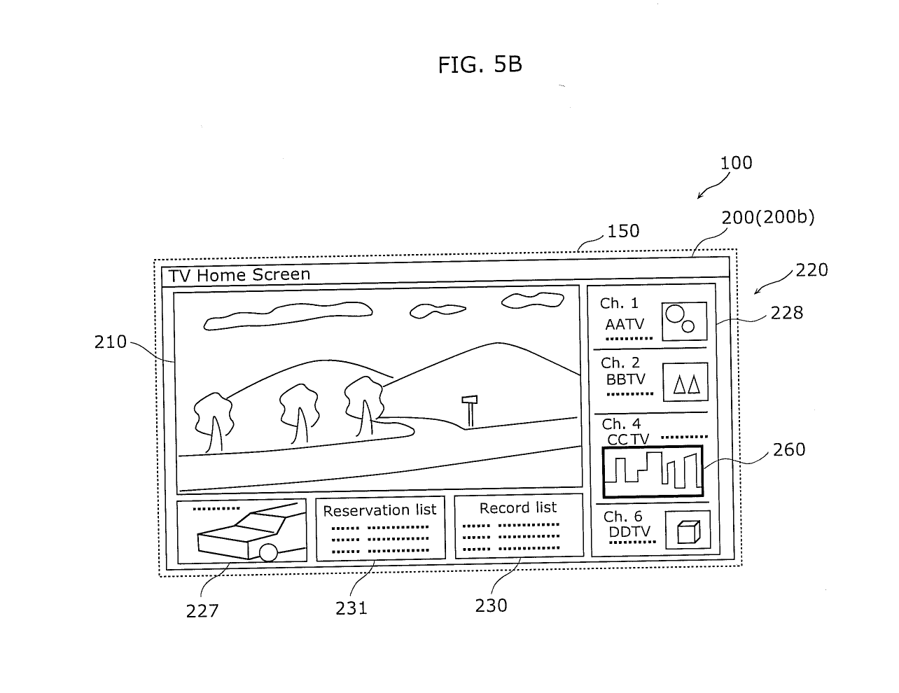

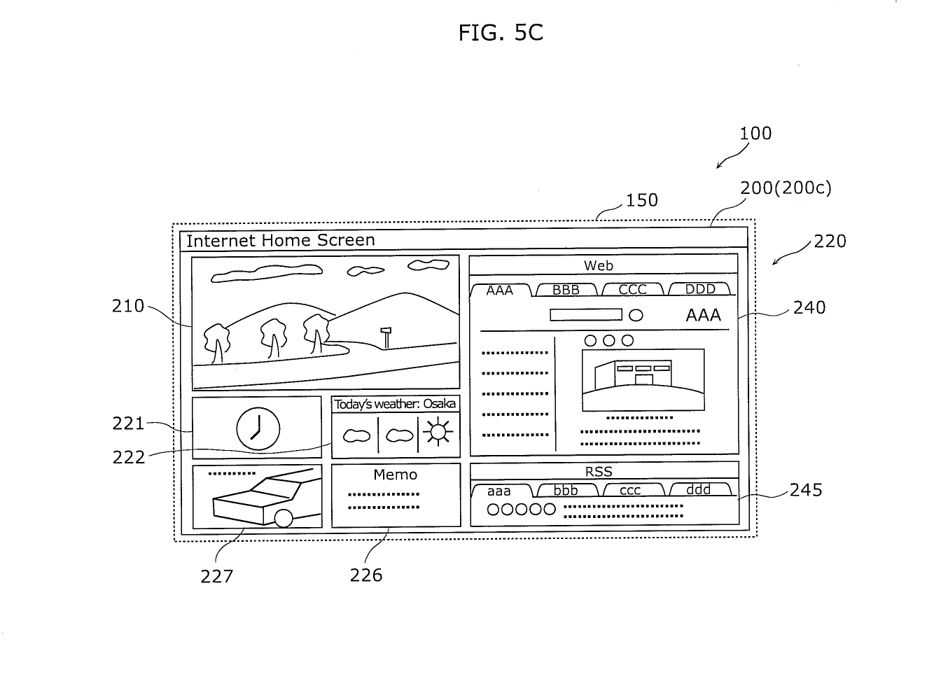

The following describes the details of the home screens 200 with reference to FIGS. 4 to 5C.

FIG. 4 illustrates an example of the basic configuration of the home screen 200 in the embodiment.

In the home screen 200 in the embodiment, the display area is divided into parts.

For example, as shown in FIG. 4, the display area of the home screen 200 is divided into rectangular areas 201 of four columns and four rows. Each of the broadcast images 210 and the app images 220 is displayed in an area formed of one or more continuous rectangular areas 201.

That is, in the home screen 200, the broadcast image 210 or the app image 220 can be allocated to each section of the display area.

For the example shown in FIG. 4, the broadcast image 210 is displayed in an area formed of the rectangular areas 201 of three columns and three rows (3×3).

It should be noted that there is an interstice area in which a background image is displayed, between the rectangular areas 201 adjacent to each other. However, when the displayed broadcast image 210 or the displayed app image 220 spreads across more than one rectangular area 201, the interstice area between the rectangular areas 201 adjacent to each other is used for the display area of the broadcast image 210 or the app image 220.

Moreover, information indicating allocation of the broadcast image 210 or the app image 220 to the rectangular areas 201 in the home screen 200 (screen layout information) is stored in the memory unit 117, for example.

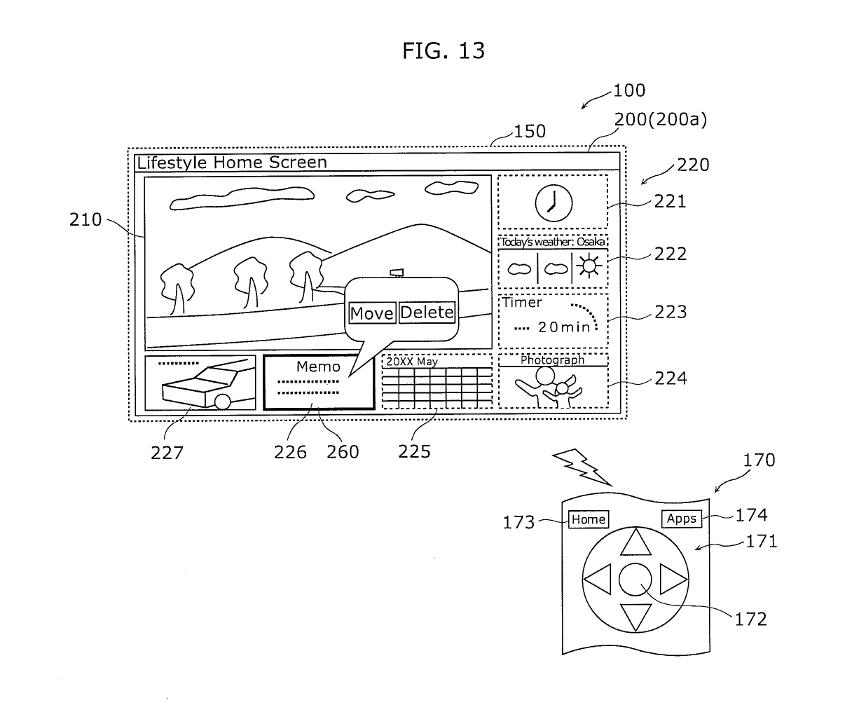

Moreover, the change of the once registered home screen 200, i.e., the update of screen layout information is possible, and the addition of the new home screen 200 is also possible. The layout change and addition of the home screen 200 will be described later with reference to FIGS. 13 to 15. The following describes three examples of such home screen 200 with reference to FIG. 5A to 5C.

It should be noted that the home screens 200 shown in FIGS. 5A to 5C are, for example, set when the televisions 100 are delivered from a factory.

FIG. 5A illustrates a first example of the home screen 200 in the embodiment.

The home screen 200 shown in FIG. 5A is the home screen 200 named “lifestyle home”, for example. The following refers to it as “lifestyle home 200a”.

The lifestyle home 200a is the home screen 200 for efficiently providing a user with information, for example, necessary for user's everyday life.

In the example shown in FIG. 5A, in addition to the broadcast image 210, the app images 220 showing a clock 221, a weather forecast 222, a timer 223, a photograph 224, a calendar 225, a memo 226, and an advertisement 227 are displayed on the lifestyle home 200a.

The clock 221 is the image of a clock app for displaying time. The weather forecast 222 is the image of a weather forecast app for displaying weather forecast information obtained via the Internet, for example.

It should be noted that the “app image” is, as described above, an image obtained by executing the app, or an image associated with the app, such as an icon for activating the app.

The timer 223 is the image of a timer app for starting a timer by a predetermined operation. The photograph 224 is the image of a photograph app for displaying photograph data stored in the memory unit 117 by a predetermined user operation, for example.

The calendar 225 is the image of a calendar app which can register information on a daily schedule, for example.

The memo 226 is the image of a memo app for storing and displaying text information inputted by a predetermined user operation, for example. The advertisement 227 is the image of an advertisement app for displaying an advertisement image obtained by the broadcast image output device 110 via the Internet, for example.

Each of these app images 220 is a still image or an image at least a part of which is a moving image.

The clock 221 is, for example, an image including the moving images of a clock generated by the control unit 116 executing the clock app.

FIG. 5B illustrates a second example of the home screen 200 in the embodiment.

The home screen 200 shown in FIG. 5B is a home screen 200 named “TV home”, for example. The following refers to it as “TV home 200b”.

The TV home 200b is the home screen 200 for efficiently providing a user with information on broadcast programs, for example.

In the example shown in FIG. 5B, in addition to the broadcast image 210, the app images 220 showing programs on different channels 228, a record list 230, a reservation list 231, and the advertisement 227 are displayed on the TV home 200b.

The programs on different channels 228 are the images of the app of programs on different channels for displaying information on broadcast programs on the air other than the broadcast program displayed as the broadcast image 210.

For example, when the broadcast program on Channel 5 (Ch.5) is displayed as the broadcast image 210, information on broadcast programs on channels other than Ch. 5 (such as the name of the broadcast station, the name of the program, and a still image obtained from moving images of the broadcast program) is displayed on the programs on different channels 228.

It should be noted that the television 100 includes two tuners (first and second tuners). For example, the first tuner receives a broadcast program to be displayed as the broadcast image 210, and the second tuner scans channels to be displayed on the programs on a different channels 228. Thus, information on broadcast programs on the channels such as still images is displayed on the programs on different channels 228.

Moreover, the television 100 further includes a third tuner. In this case, for example, when a focus 260 (a thick line frame in FIG. 5B) is focused on a still image by the user operation of the remote control 170, i.e., when the still image is selected, a broadcast program (moving images) corresponding to the still image, received by the third tuner can be displayed within the programs on different channels 228.

That is, the control unit 116 of the broadcast image output device 110 controls the output unit 114 to output the TV home 200b obtained after the still image within the programs on different channels 228 which is focused on by the focus 260 has been replaced with the moving images of the broadcast program corresponding to the still image.

It should be noted that in this case, an operation such as depressing a select key 172 allows for control such as switching between (i) the moving images of one of the above broadcast programs displayed within the programs on different channels 228 and (ii) the moving images of the broadcast program displayed as the broadcast image 210.

The record list 230 is the image of a record list app for displaying the list of broadcast programs recorded on a video recorder connected to the television 100, for example. For example, when the broadcast image output device 110 obtains list information showing the list of the recorded broadcast programs from the video recorder, and processes the list information with the record list app, the record list 230 can be obtained.

The reservation list 231 is the image of a reservation list app for displaying the list of broadcast programs scheduled for recording by a video recorder connected to the television 100. For example, when the broadcast image output device 110 obtains reservation information showing the list of broadcast programs scheduled for recording from the video recorder, and processes the reservation information with the reservation list app, the reservation list 231 can be obtained.

FIG. 5C illustrates a third example of the home screen 200 in the embodiment.

The home screen 200 shown in FIG. 5C is the home screen 200 named “Internet home”, for example. The following refers to it as “Internet home 200c”.

The Internet home 200c is the home screen 200 for efficiently providing a user with various information obtainable via the Internet, for example.

In the example shown in FIG. 5C, in addition to the broadcast image 210, the app images 220 showing a bookmark browser 240, an RSS reader 245, the clock 221, the weather forecast 222, the memo 226, and the advertisement 227 are displayed in the Internet home 200c.

The bookmark browser 240 is the image of a browser app for displaying website data obtained from each of one or more uniform resource locators (URLs) registered as bookmarks.

For example, when the control unit 116 gives the output unit 114 an instruction to display the Internet home 200c on the display 150, this becomes a trigger for the control unit 116 to start obtaining the website data.

The RSS reader 245 is the image of an RSS reader app for automatically downloading RSS (RDF site summary/rich site summary/really simple syndication) information on a specified website at regular time intervals, and displaying a link to an article when there is an update.

The output unit 114 creates the Internet home 200c including the bookmark browser 240 and the RSS reader 245 using the website data obtained by the control unit 116 and RSS information, and outputs to the display 150.

It should be noted that one or more URLs registered as a bookmark and one or more URLs from which RSS information is obtained are stored in the memory unit 117, for example. Moreover, these URLs may be, for example, obtained from a server connected to the Internet when the broadcast image output device 110 outputs the Internet home 200c.

Here, the bookmark browser 240 and the RSS reader 245 are different from other app images 220 such as the clock 221 in that the displayed bookmark browser 240 and RSS reader 245 use a plurality of rectangular areas 201 (cf. FIG. 4).

Specifically, the displayed bookmark browser 240 uses two columns and two rows (2×2) of the rectangular areas 201. The displayed RSS reader 245 uses one column and two rows (1×2) of the rectangular areas 201.

The broadcast image output device 110 in the present embodiment can output each of the home screens 200 including the above-mentioned home screens 200.

When each of the broadcast images 210 and the app images 220 allocated to one of the home screens 200 is selected and confirmed (this is the same as the operation of depressing the select key of the remote control 170 in the present embodiment) by a user, processing such as change to full screen display is performed.

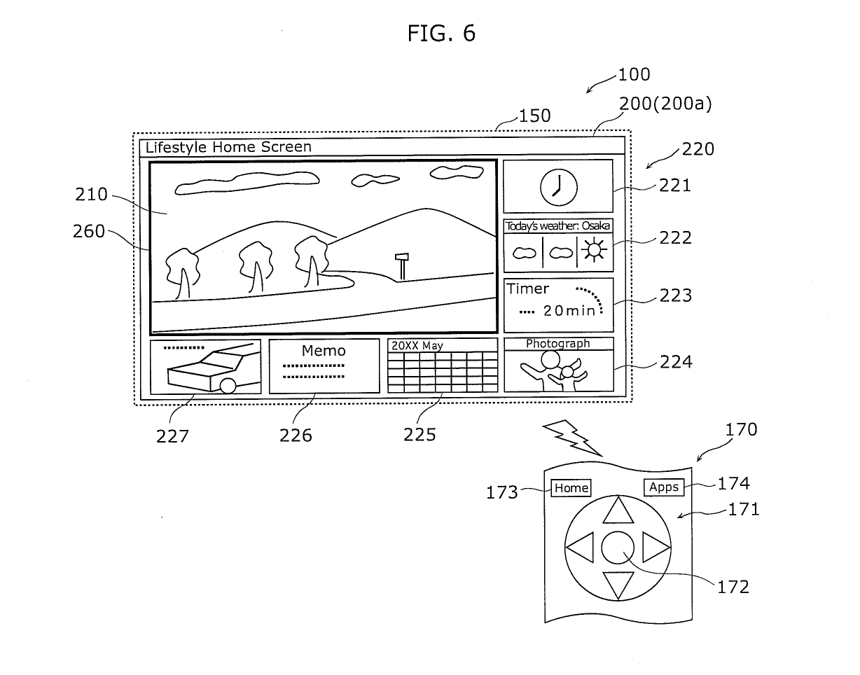

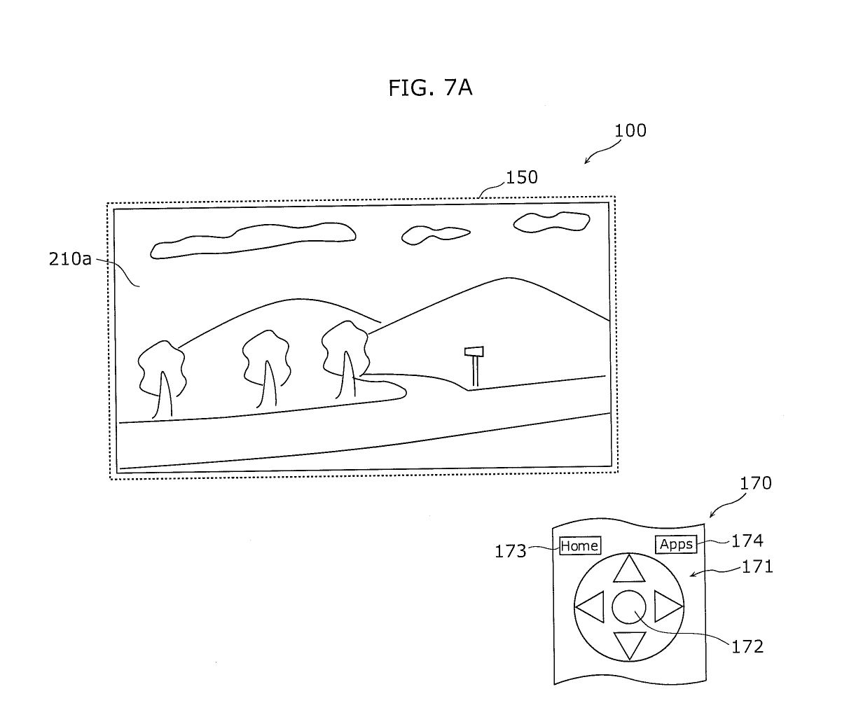

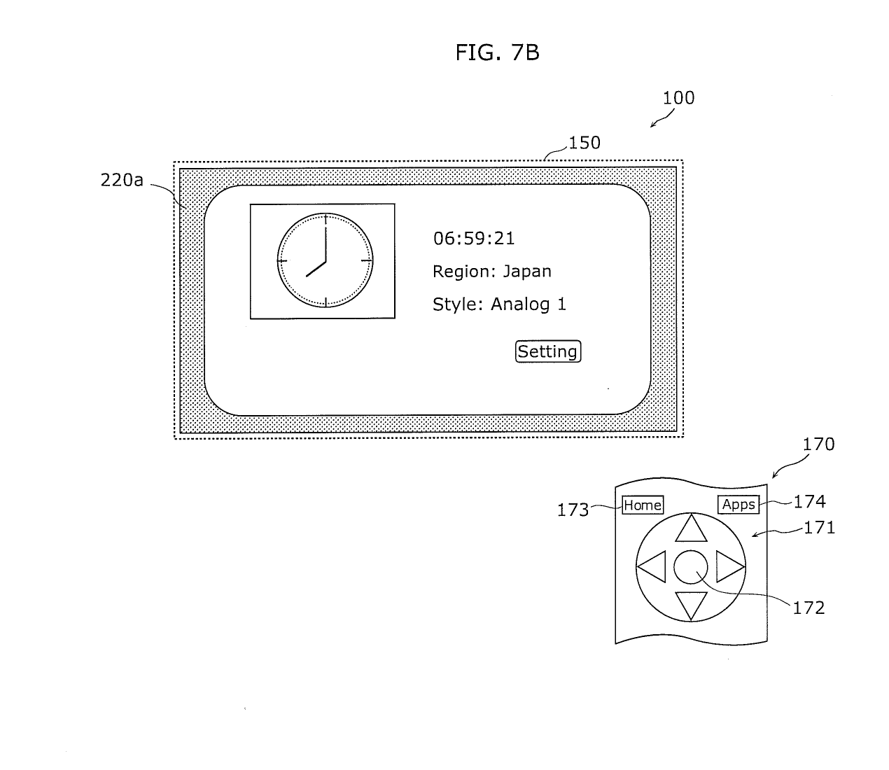

Therefore, the following describes an operation example when the broadcast image 210 and the app image 220 are selected and confirmed, with reference to FIGS. 6 to 7B.

### [1-4. Operation After Selection on Home Screen]

FIG. 6 illustrates a state in which the broadcast image 210 is selected in the home screen 200 in the embodiment.

FIG. 7A illustrates a state in which the broadcast image 210 is displayed on the full screen of the television 100 in the embodiment.

FIG. 7B illustrates a state in which an app setting screen is displayed on the full screen of the television 100 in the embodiment.

For example, the following assumes a case where the focus 260 is focused on the broadcast image 210 in the home screen 200 (lifestyle home 200a in FIG. 6), i.e., a case where the broadcast image 210 is selected.

In this state, when the select key 172 of the remote control 170 is depressed, the control unit 116 of the broadcast image output device 110 accepts a predetermined instruction for the broadcast image 210 by user operation.

As a result, as shown in FIG. 7A, the broadcast images 210 is enlarged and displayed on the full screen of the display 150. That is, an enlarged broadcast image 210a obtained by enlarging the broadcast image 210 is outputted by the output unit 114.

Moreover, when the app image 220 is selected and confirmed by user operation, the control unit 116 performs processing according to the app image 220.

For example, in the lifestyle home 200a shown in FIG. 6, the following assumes a case where the focus 260 is moved to the clock 221 and the select key 172 is depressed.

In this case, the control unit 116 causes the output unit 114 to output a screen for setting a clock app associated with the clock 221. As a result, as shown in FIG. 7B, an app screen 220a is displayed on the full screen of the display 150 instead of the home screen 200 (lifestyle home 200a).

When the “Setting” key is selected and confirmed in the app screen 220a shown in FIG. 7B, the display screen of the display 150 transitions to a setting screen which accepts settings such as the setting of an area where the television 100 is set and the setting of a display style.

It should be noted that the app screen 220a shown in FIG. 7B is an example of a screen displayed when a predetermined instruction is given for the clock 221 which is a kind of the app image 220. That is, the processing performed when the select key 172 is depressed is different according to apps associated with selected app images 220.

For example, there are a case where only the enlarged display of the app image 220 is executed, a case where the app screen 220a showing the main function of the app is displayed, a case where the display of the app image 220 is maintained (i.e., even when the select key 172 is depressed, there is no change in the selected app image 220), and so on.

Moreover, as shown in FIG. 6, the remote control 170 includes a Home key 173 and an Apps key 174. The Home key 173 is a key for displaying the home screen 200. The Apps key 174 is a key for displaying an app list screen.

That is, the television 100 changes display screens according to instructions by user operation.

### [1-5. Transition of Display Screen]

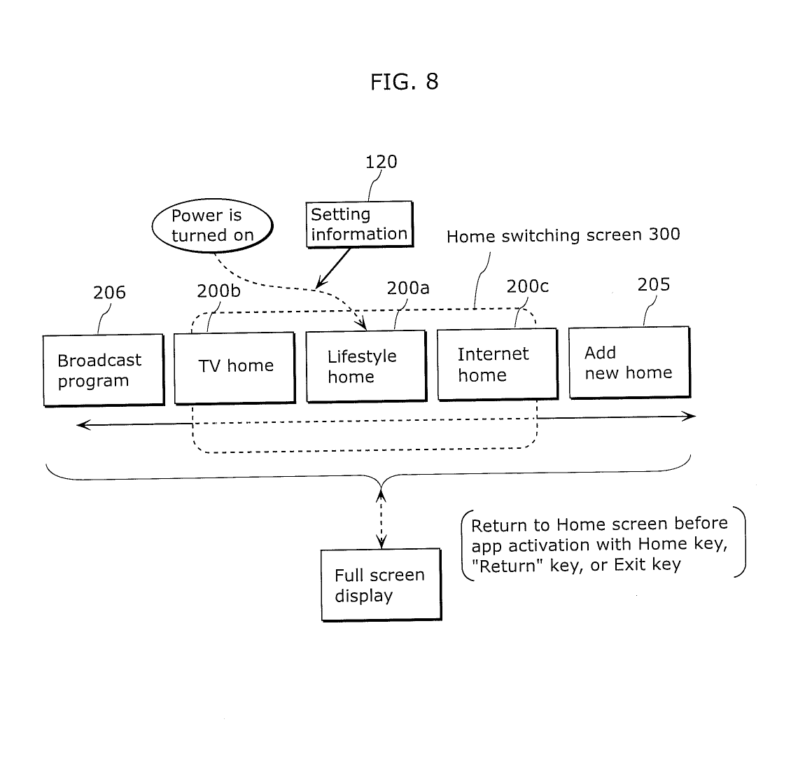

The following describes an example of the transition of a display screen in the television 100 with reference to FIGS. 8 to 10.

FIG. 8 is a first figure illustrating an example of the transition of the display screen in the television 100 in the embodiment.

In the television 100 in the embodiment, when the power is turned on, the control unit 116 of the broadcast image output device 110 selects one of the home screens 200 in accordance with preset setting information 120.

For example, when the lifestyle home 200a is selected, the lifestyle home 200a is outputted by the output unit 114 and displayed on the display 150, as an initial screen which can accept user operation, i.e., an input from the user.

After that, as described above, when the broadcast image 210 or the app image 220 is selected and confirmed, the enlarged broadcast image 210a or the app screen 220a is displayed on the full screen of the display 150.

In this state, when the Home key 173 is depressed, the output unit 114 outputs the lifestyle home 200a in accordance with control by the control unit 116. That is, the display 150 is switched from the full screen display of the enlarged broadcast image 210a or the app screen 220a to the lifestyle home 200a.

It should be noted that the display switching can be performed by a Return key, an Exit key (not shown) or the like instead of the Home key 173.

Moreover, in the television 100, the home screens 200 are switched according to a home switching instruction from a user.

For example, when the lifestyle home 200a is displayed on the display 150, a predetermined user operation allows for displaying, on the display 150, the TV home 200b or the Internet home 200c which is other home screen 200.

It should be noted that a broadcast program 206 is a screen for the full screen display of a broadcast program on a predetermined channel. However, the broadcast program 206 can be also used as a kind of the home screen 200.

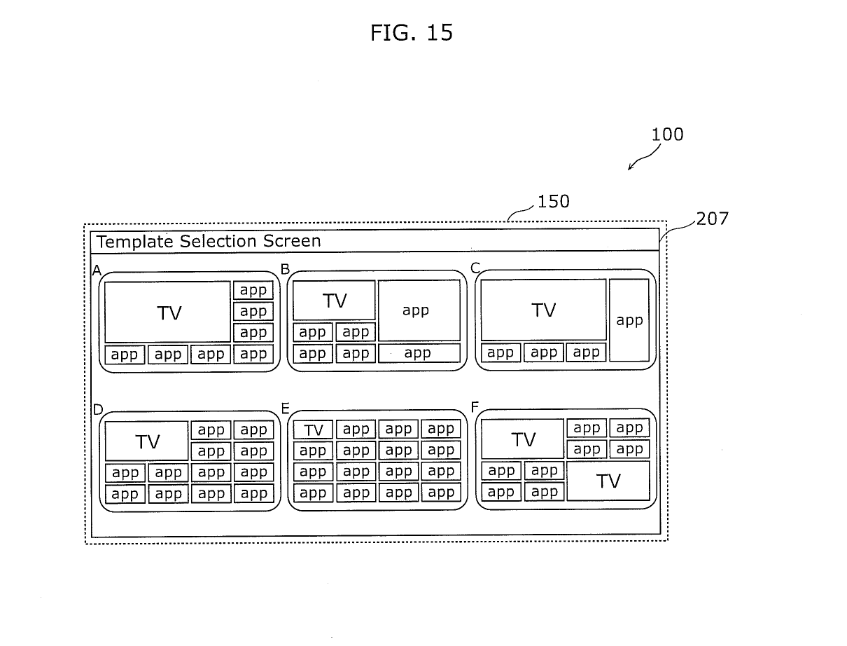

Moreover, add new home 205 is a screen for creating a new home screen 200 and selecting a template, for example. However, the add new home 205 can be also used as a kind of the home screen 200. An operation example when the add new home 205 is selected will be described later with reference to FIG. 15.

Here, user's instruction for switching the home screens 200 (home switching instruction) is accepted by a home switching screen in the present embodiment.

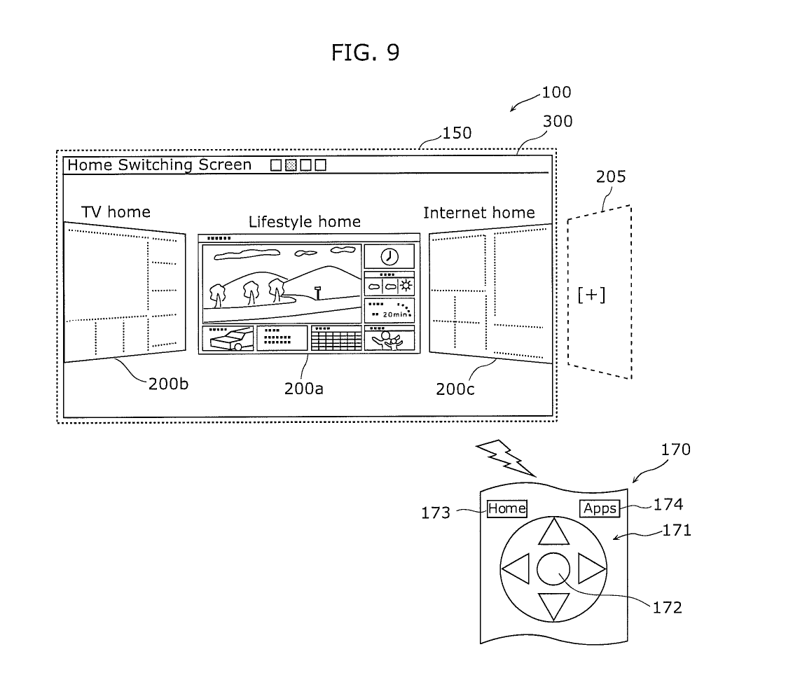

FIG. 9 illustrates an example of a home switching screen 300 in the embodiment.

In a state in which the home screen 200 such as the lifestyle home 200a is displayed on the display 150, when the Home key 173 is depressed, for example, the home switching screen 300 shown in FIG. 9 is displayed in the present embodiment.

As shown in FIG. 9, the home screens 200 are displayed in the home switching screen 300. Specifically, in the home switching screen 300, the center of the three home screens 200 is selected.

Moreover, when the user operates an arrow key 171 of the remote control 170, the laterally arranged home screens 200 are scrolled sideways. Thus, the home screen 200 in a selected state is changed successively.

Furthermore, when the select key 172 is depressed, the home screen 200 selected at this time point is displayed on the full screen of the display 150. For example, in the state shown in FIG. 9, when the select key 172 is depressed, the display 150 is switched from the home switching screen 300 to the lifestyle home 200a.

It should be noted that not all of the home screens 200 have to be displayed on the home switching screen 300.

That is, at least parts of at least two of the home screens 200 may be displayed in the home switching screen 300. This allows the user to select one of the home screens 200 to be displayed on the display 150, in the home switching screen 300.

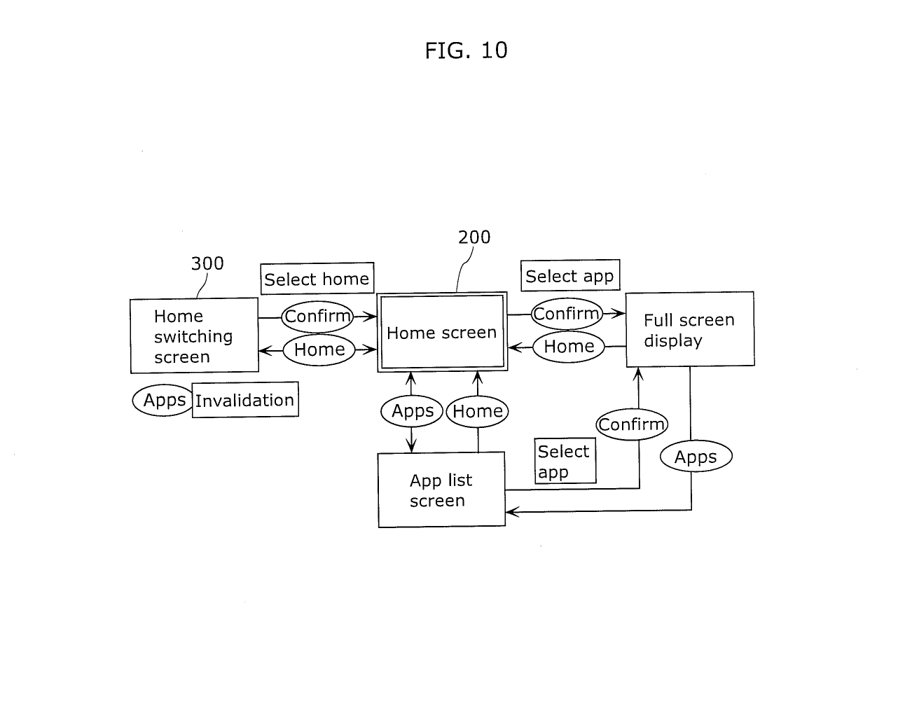

FIG. 10 is a second figure illustrating an example of the transition of the display screen in the television 100 in the embodiment.

It should be noted that in FIG. 10, “Select” corresponds to the select key 172, “Home” corresponds to “Home key 173”, and “Apps” corresponds to the Apps key 174.

For example, in a state in which the home switching screen 300 is displayed on the display 150, when the select key 172 of the remote control 170 is depressed, the home screen 200 selected in the home switching screen 300 is displayed on the display 150.

Moreover, in a state in which the home switching screen 300 is displayed on the display 150, when the Home key 173 of the remote control 170 is depressed, the home screen 200 displayed before the display of the home switching screen 300 is, for example, displayed on the display 150.

Moreover, for example, in a state in which the home screen 200 is displayed on the display 150, when the Apps key 174 of the remote control 170 is depressed, an app list screen is displayed on the display 150.

It should be noted that although a display example of the app list screen is not shown, the list of apps which are, for example, executable by the broadcast image output device 110 at the time when the Apps key 174 is depressed is displayed. Moreover, when an app is selected by the user operation of the remote control 170, and the select key 172 is depressed, the app screen 220a corresponding to the selected app is displayed on the full screen.

Thus, in the television 100 in the present embodiment, the broadcast image output device 110 can change screens to be displayed on the display 150 according to the user operation of the remote control 170.

Moreover, the broadcast image output device 110 can further accept the settings, changes, and others of the home screen 200 to be displayed as an initial screen.

### [1-6. Home Screen Button]

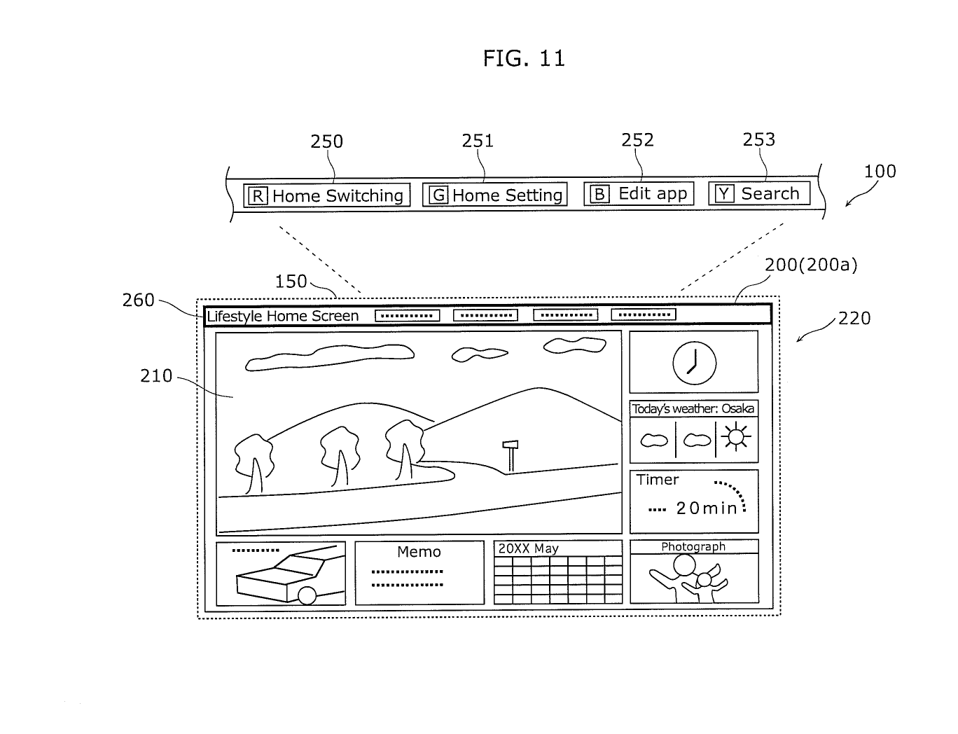

FIG. 11 illustrates a display example of buttons for the various settings and the like of the home screen 200 in the embodiment.

For example, when the focus 260 is focused on the upper portion of the home screen 200, the control unit 116 controls the output unit 114 to display a group of buttons shown in FIG. 11 at the upper portion.

In the example shown in FIG. 11, a home switching button 250, home setting button 251, an app edit button 252, and a search button 253 are displayed.

It should be noted that any button can be selected by the operation of the arrow key 171 of the remote control 170, and the selected button is depressed by depressing the select key 172.

Moreover, each button is depressed by depressing any one of “blue”, “red”, “green”, and “yellow” keys of the remote control 170 respectively associated with the buttons.

Moreover, the control unit 116 controls to cause the output unit 114 to output a screen corresponding to a depressed button to the display 150.

Specifically, as same as when the Home key 173 of the remote control 170 is depressed, the home switching screen 300 is displayed on the display 150 when the home switching button 250 is depressed.

When the home setting button 251 is depressed, a home setting screen for setting the home screen 200 is displayed.

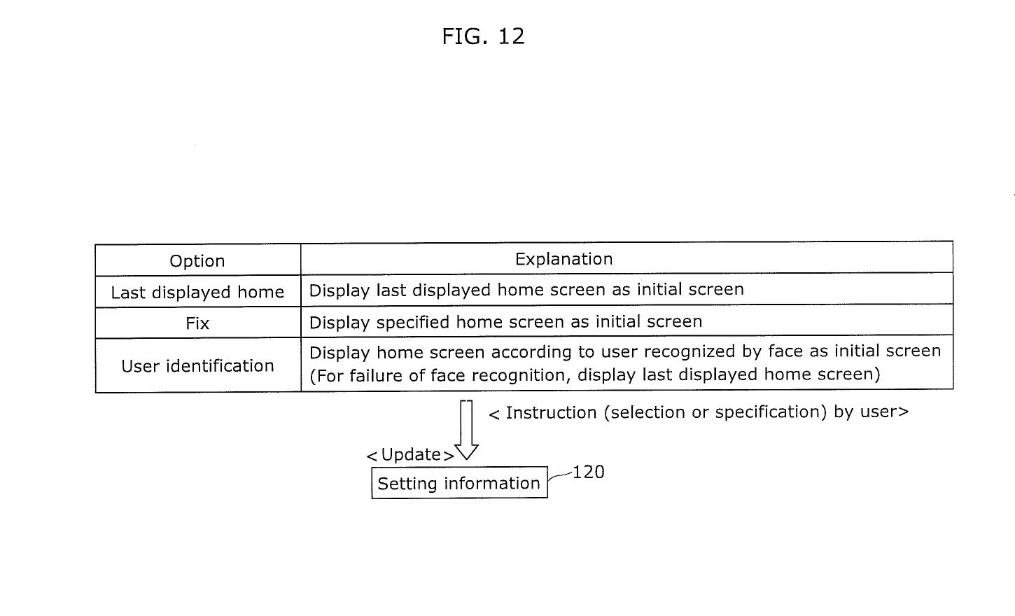

For example, a screen is displayed in which the user can select the home screen 200 to be displayed as an initial screen which appears after the power is turned on. The settings of the initial screen will be described later with reference to FIG. 12.

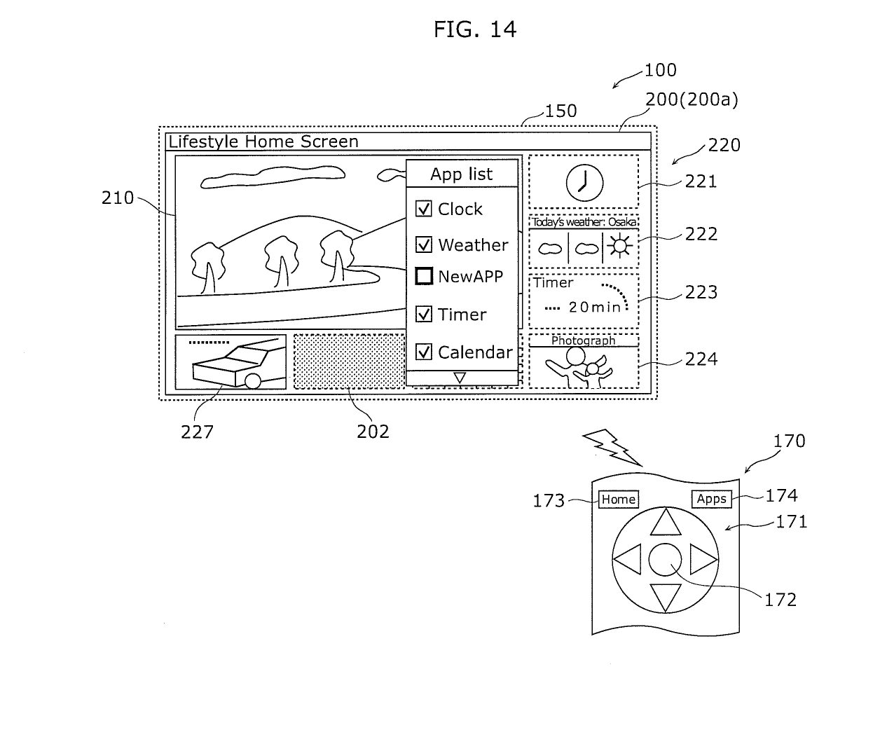

When the app edit button 252 is depressed, a screen for the adding, deleting, and the like of the app images 220 shown in the home screen 200 displayed on the display 150 at that time is displayed. That is, a screen for editing apps associated with the home screen 200 is displayed on the display 150. The edition of apps will be described later with reference to FIGS. 13 and 14.

When the search button 253 is depressed, a search screen for searching, for example, the memory unit 117, a device such as a video recorder connected to the television 100, and a server accessible via the Internet is displayed.

FIG. 12 illustrates an example of options for an initial screen in the embodiment.

A user can update the setting information 120 by selecting one of the three options shown in FIG. 12, for example.

For example, when the user selects “Last displayed home, after the selection and at a time point when the television 100 is turned off, the last home screen which is the home screen 200 last outputted by the output unit 114 is registered in the setting information 120 as an initial screen.

As a result, when the television 100 is turned on (that is, when the broadcast image output device 110 is turned on) after that, the control unit 116 selects the last home screen in accordance with the setting information 120, and causes the output unit 114 to output the home screen as the initial screen.

Moreover, when the user selects “Fix”, the user can specify one home screen from among the home screens 200, and the specified home screen 200 is registered in the setting information 120 as the initial screen.

As a result, when the television 100 is turned on after that, the control unit 116 always selects the home screen 200 specified by the user in accordance with the setting information 120, and causes the output unit 114 to output as the initial screen.

Moreover, when the user selects “User identification”, the user can specify one home screen suitable for the user herself or himself from among the home screens 200, and the specified home screen 200 is registered in the setting information 120 as the initial screen.

As a result, when the television 100 is turned on after that, the control unit 116 identifies the user by face recognition using a camera in the television 100, for example. The control unit 116 further selects the home screen 200 suitable for the indentified user which is indicated by the setting information 120, and causes the output unit 114 to output as the initial screen.

It should be noted that for failure of the face recognition, the control unit 116, for example, causes the output unit 114 to display the last home screen as the initial screen.

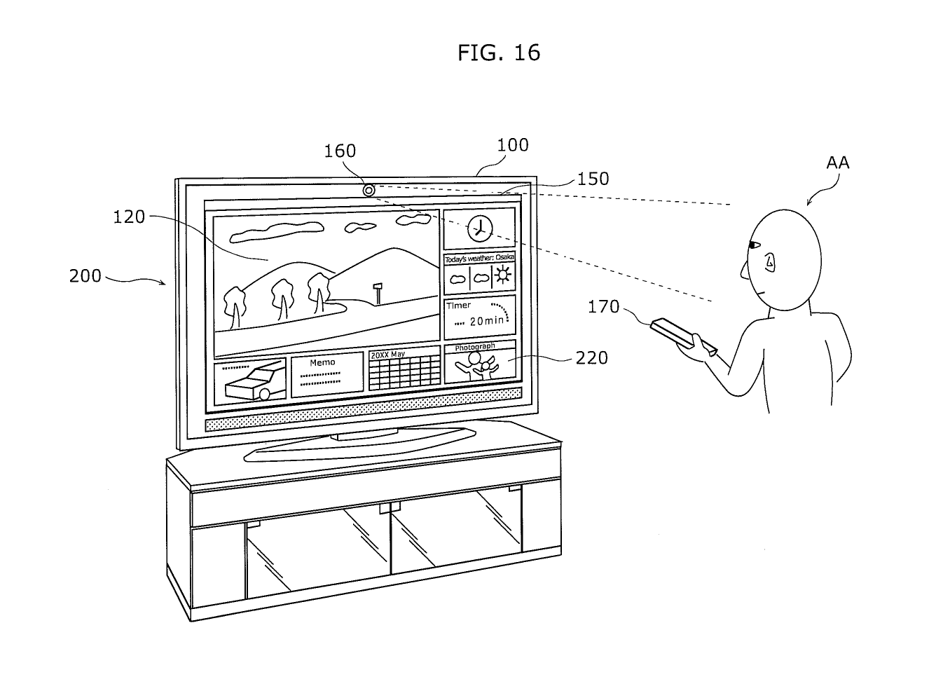

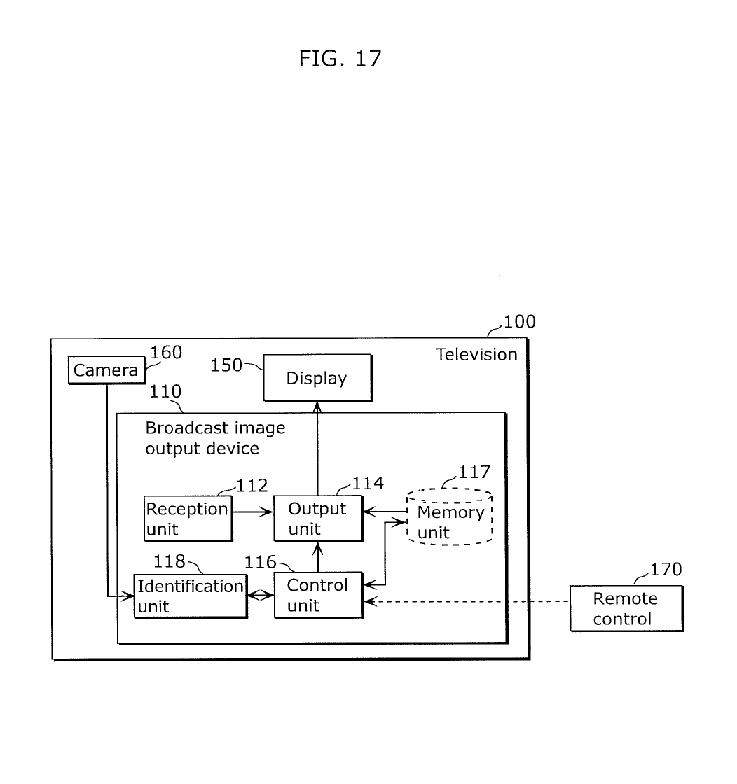

It should be noted that an embodiment as mentioned above in which the home screen 200 as an initial screen is selected in accordance with the identification result of the user will be described later with reference to FIGS. 16 and 17.

Moreover, as the setting items of the home screen 200, the setting and change of the name of a home screen and the setting and change of a background image are exemplified in addition to the above setting of the initial screen.

Thus, the control unit 116 can update the setting information 120 in accordance with an instruction by the user, and select the home screen 200 as the initial screen in accordance with the setting information 120 after the update.

It should be noted that in an initial state before the user updates the setting information 120, a “Last displayed home” is registered in the setting information 120, for example. Moreover, for example, after first turning on of the television 100 and in the initial setting of the television 100, the setting information 120 is updated according to user's instruction.

FIG. 13 illustrates a first example of an app edit screen in the embodiment.

FIG. 14 illustrates a second example of the app edit screen in the embodiment.

For example, in the state where the lifestyle home 200a is displayed on the display 150, when the app edit button 252 shown in FIG. 11 is depressed, the lifestyle home 200a shown in FIG. 13 is displayed on the display 150.

Specifically, as shown in FIG. 13, in the lifestyle home 200a, the app images 220 which can be at least deleted or moved are surrounded by dotted lines, for example. These app images 220 are displayed in a different way from the usual display.

In this state, for example, when the focus 260 is focused on the memo 226, the options “Move” or “Delete” are displayed as shown in FIG. 13. That is, the control unit 116 of the broadcast image output device 110 controls the output unit 114 so that an image for editing the selected (focused on by the focus 260) memo 226 is superimposed on the lifestyle home 200a.

In this case, when the user selects and confirms “Delete” by the operation of the remote control 170, the memo 226 is deleted from the lifestyle home 200a as shown in FIG. 14.

In this state, when the focus 260 is focused on an empty area 202 which is the empty rectangular area 201 generated by the deletion of the memo 226, and the select key 172 is depressed, options for apps which can be allocated to the empty area 202 are displayed as shown in FIG. 14.

That is, the control unit 116 of the broadcast image output device 110 controls the output unit 114 so as to superimpose, on the lifestyle home 200a, an image for selecting apps to be allocated to the empty area 202.

Specifically, as shown in FIG. 14, the list of apps is superimposed on the lifestyle home 200a. In the list, while ticks are placed in check boxes, for the apps already allocated to the lifestyle home 200a, a tick is not placed in a check box, for the app which is not allocated to the lifestyle home 200a.

For the case shown in FIG. 14, by the user placing a tick in the check box for the app named “NewAPP”, the control unit 116 accepts an instruction that the app image 220 of the NewAPP should be allocated.

The control unit 116 further allocates the app image 220 of NewAPP to the empty area 202 by controlling the output unit 114. That is, a new app “NewAPP” is added to the lifestyle home 200a.

It should be noted that in FIG. 13, when the user selects and confirms “Move” by the operation of the remote control 170, the user further selects and confirms the existing app image 220 to which the memo 226 is moved. As a result, the selected app image 220 and the memo 226 to be moved are switched.

Thus, the broadcast image output device 110 performs editing apps allocated to the home screen 200 in the television 100 in the present embodiment.

### [1-7. Addition of Home Screen]

As mentioned above, the broadcast image output device 110 in the present embodiment can create a new home screen 200 in addition to the edit processing of the existing home screens 200.

The broadcast image output device 110 causes the output unit 114 to output more than one template for creating a new home screen 200, for example. This allows the user to easily create a new home screen 200.

FIG. 15 illustrates an example of a template selection screen 207 in the embodiment.

The control unit 116 reads pieces of template information indicating templates from the memory unit 117, for example, and controls the output unit 114, so that the template selection screen 207 is displayed on the display 150.

The template selection screen 207 shown in FIG. 15 shows six templates from A to F. It should be noted that “TV” in each template indicates an area to which the broadcast image 210 can be allocated, and “app” indicates an area to which the app image 220 can be allocated.

Moreover, when the add new home 205 is selected and confirmed in the home switching screen 300 shown in FIG. 9, the template selection screen 207 is displayed on the display 150.

By operating the remote control 170, the user selects and confirms one of the templates shown in the template selection screen 207. Thus, the home screen 200 in which only the broadcast image 210 is allocated to the selected template, for example as shown in FIG. 4 is displayed.

After that, the list of apps to be allocated to the home screen 200 as shown in FIG. 14 is superimposed on the home screen 200, and one or more apps selected by user's operation of the remote control 170 are allocated to the home screen 200.

Moreover, processing required for creating a new home screen 200, such as the setting of the name of the home screen 200 is performed.

Screen layout information corresponding to the home screen 200 thus created is, for example, stored in the memory unit 117, and after that, when the home screen 200 is displayed on the display 150, the screen layout information is referred to by the control unit 116 and the output unit 114.

It should be noted that the template selection screen 207 is an example of a screen for allowing the user to select a template for creating a new home screen 200 from several templates, and other embodiments of the display may be employed.

For example, a template for creating the new home screen 200 may be selected by laterally aligning templates as the home switching screen 300 shown in FIG. 9, and scrolling from side to side.

### [1-8. Home Screen Selection by User Identification]

As mentioned above, the broadcast image output device 110 in the embodiment can select one of the home screens 200 which is to be displayed as an initial screen, in response to a user identification result.

FIG. 16 is a figure to explain face recognition in the embodiment.

FIG. 17 is a block diagram illustrating a basic functional configuration of the television 100 having a face recognition function in the embodiment.

For example, as shown in FIG. 16, a camera 160 is placed at the top center of the television 100 as shown in FIG. 16. It should be noted that the camera 160 does not have to be included in the television 100, but the camera 160 may be connected to the television 100 as an external image capturing device.

Moreover, for example, an image capturing device used for a teleconference, a TV phone, and the like which use the television 100 may be used as the camera 160 used for face recognition.

Moreover, the broadcast image output device 110 shown in FIG. 17 includes an identification unit 118. The identification unit 118 obtains feature information indicating the physical feature of a user, and identifies the user in accordance with the obtained feature information. In the present embodiment, the user is identified using image data obtained from the camera 160 and face image data (face data) of the user.

For example, the control unit 116 obtains face data obtained by a user AA capturing the image of her or his face in advance using the camera 160, and causes the memory unit 117 to store the face data.

Moreover, the control unit 116 creates user-home association information for associating the face data and one of the home screens 200, in accordance with an instruction from the user AA, and causes the memory unit 117 to store the information.

After that, when the television 100 is turned on and the setting information 120 indicates “User identification”, the control unit 116 of the broadcast image output device 110 reads the face data and the user-home association information which are stored in the memory unit 117, and transmits to the identification unit 118.

The identification unit 118 obtains the data of an image captured by the camera 160 at the time point when the television 100 is turned on. The identification unit 118 further identifies an area assumed to be a human face in the image represented by the obtained image data, and compares the image data of the identified area and the face data received from the control unit 116. That is, the control unit 116 judges whether or not a human face represented by the face data is included in the image captured by the camera 160.

For success of face recognition by this judge, that is, when the control unit 116 judges that the human face represented by the face data is included in the image captured by the camera 160, the home screen 200 suitable for the person (user AA) which is indicated by the user-home association information is identified.

The control unit 116 further causes the output unit 114 to output the identified home screen 200.

Thus, the home screen 200 associated with the user AA in the television 100 is automatically selected from among the home screens 200, and displayed on the display 150.

It should be noted that although the above operation example describes face recognition for one user (user AA), more than one user can be registered in one television 100. That is, the television 100 can selectively output the home screen 200 corresponding to each user.

Moreover, when more than one human face is included in an image captured by the camera 160 when the television 100 is turned on, the identification unit 118 identifies a face closest to the center of the image as a face to be used for face recognition, for example. Moreover, for failure of recognizing the identified face, the identification unit 118 performs recognition processing of the remaining faces in order closest to the center of the image, for example.

### [1-9. Advantages and Others]

Thus, in the present embodiment, the television 100 includes the broadcast image output device 110 and the display 150 for displaying images outputted from the broadcast image output device 110.

Moreover, in the present embodiment, the broadcast image output device 110 includes the reception unit 112 for receiving a broadcast, the output unit 114 for outputting each of the home screens 200, and the control unit 116.

In each of the home screens, the broadcast image 210 relating to a broadcast received by the reception unit 112 or an image other than the broadcast image (app image 200 in the present embodiment) can be allocated to each section of a display area. Here, the broadcast image 210 and the image other than the broadcast image can be selected by user operation.

Moreover, the control unit 116 selects one of the home screens 200 in accordance with the preset setting information 120. The control unit 116 further causes the output unit 114 to output the selected home screen 200 as an initial screen that is ready to accept the user operation and appears after the broadcast image output device 110 is turned on.

This allows the broadcast image output device 110 to output the home screen 200 suitable for a user as an initial screen. This can, for example, avoid the processing such as switching from the home screen 200 displayed on the display 150 as the initial screen to another home screen 200 according to user operation.

That is, according to the broadcast image output device 110 in the present embodiment, processing relating to the display of the initial screen can be efficiently performed.

Moreover, in the present embodiment, when accepting a home switching instruction which is the instruction for switching from the home screen 200 outputted by the output unit 114 to another home screen 200, the control unit 116 causes the output unit 114 to output the another home screen 200 in accordance with the home switching instruction.

This allows the user to display different kinds of home screens 200 in which allocated apps (app images 200) are different, for example.

Moreover, in the present embodiment, the output unit 114 outputs the home switching screen 300 which displays at least parts of at least two of the home screens 200. During the time when the output unit 114 is outputting the home switching screen 300, the control unit 116 accepts a home switching instruction, more specifically, specification for one home screen 200 from among the at least two of the home screens 200.

This allows the user to easily switch the home screens 200. As a result, it is possible to efficiently perform processing relating to the switching of the home screens 200.

Moreover, in the present embodiment, the output unit 114 outputs one of the home screens 200 which includes both the broadcast image 210 and an image other than the broadcast image 210 (app image 220 in the present embodiment), in accordance with control by the control unit 116.

For example, this allows the user to watch a broadcast program, and also allows for providing the user with various information from each app.

Moreover, in the present embodiment, when the broadcast image 210 is displayed on a part of the home screen 200, and the control unit 116 accepts a predetermined instruction for the broadcast image 210, the control unit 116 causes the output unit 114 to output the enlarged broadcast image 210a obtained by enlarging the broadcast image 210.

This allows the user to watch the broadcast program displayed in the broadcast image 210 which is a part of the home screen 200, on the larger enlarged broadcast image 210a.

Moreover, in the present embodiment, when the broadcast image output device 110 is turned on, the control unit 116 selects the last home screen in accordance with the setting information 120 indicating the last home screen which is one of the home screens 200 last outputted by the output unit 114, to cause the output unit 114 to output the selected last home screen as an initial screen.

Moreover, in the present embodiment, the control unit 116 further updates the setting information 120 in accordance with user's instruction. After the update of the setting information 120, when the broadcast image output device 110 is turned on, the control unit 116 selects the home screen 200 indicated by the updated setting information 120, to cause the output unit 114 to output the selected home screen 200 as an initial screen.

This allows the user to freely change the home screen 200 displayed as the initial screen all the time.

Moreover, in the present embodiment, the broadcast image output device 110 further obtains feature information indicating the physical feature of the user, and includes the identification unit 118 for identifying the user in accordance with the obtained feature information. The control unit 116 further selects one of the home screens 200 in response to an identification result obtained by the identification unit 118, to cause the output unit 114 to output the selected home screen 200.

Thus, for example when more than one user uses the television 100, the home screen 200 suitable for each user is automatically selected, and is displayed as the initial screen.

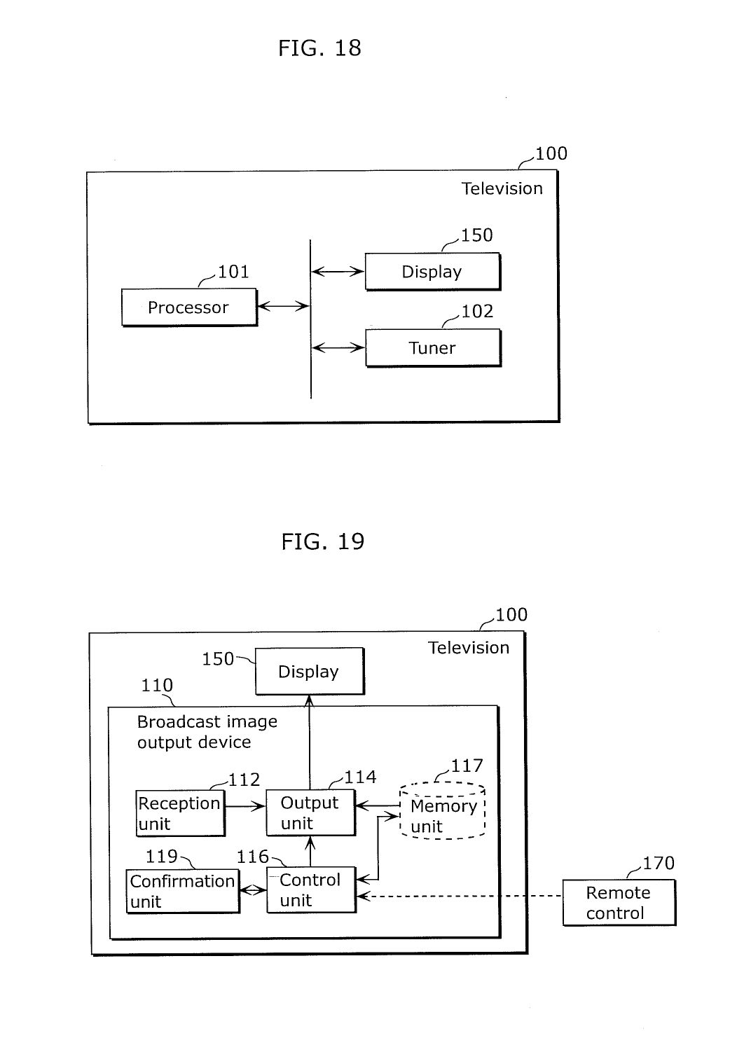

Moreover, the television 100 in the present embodiment can be represented as the following with a processor 101, a tuner 102, and the display 150, as shown in FIG. 18, for example.

That is, the television 100 in the present embodiment includes the tuner 102 for receiving a broadcast, the display 150 capable of displaying the broadcast image 210 relating to the broadcast received by the tuner 102, and the processor 101 for controlling the display of the display 150. The display 150 displays one of the home screens 200 in accordance with control by the processor 101. The processor 101 selects one of the home screens 200 in accordance with the preset setting information 120, to cause the display 150 to display the selected home screen 200 as an initial screen that is ready to accept user operation and appears after the broadcast image output device 110 is turned on.

It should be noted that the tuner 102 may serve as the reception unit 112 in the present embodiment, for example. Moreover, the processor 101 may serve as the control unit 116 in the present embodiment, for example. In other words, the reception unit 112 may be realized by the tuner 102. In addition, the control unit 116 may be realized by the processor 101.

### Other Embodiment(s)

Thus, the embodiment was described as an example of the art disclosed by the present disclosure. However, the art in the present disclosure is not limited to this, but is applicable to an embodiment obtained after change, replacement, addition, deletion, and so on. Moreover, it is possible to make a new embodiment by combining structural elements described in the above embodiment.

Therefore, the following exemplifies another embodiment.

In the above embodiment, three home screens 200 exemplified as the home screen 200 (cf. FIGS. 5A to 5C) each include the broadcast image 210. However, the output unit 114 may output, as the home screen 200, the home screen 200 which does not include the broadcast image 210 but includes one or more app images 220.

Moreover, not all of the display areas in the home screen 200 have to be filled with the broadcast image 210 or app image 220.

For example, in the lifestyle home 200a (cf. FIG. 5A), at least one of the seven allocated app images 220 does not have to be present. In this case, a background image set for the lifestyle home 200a may be displayed on the empty area 202 generated due to the absence of the app image 220, for example.

Moreover, in the above embodiment, as shown in FIG. 4, the home screen 200 is divided into rectangular areas 201 of four columns and four rows (4×4), and the broadcast image 210 is displayed in the area formed of the rectangular areas 201 of 3 x 3 in the lifestyle home 200a, for example.

However, each of the broadcast images 210 and the app images 220 may be changed in size within the home screen 200.

For example, in the Internet home 200c shown in FIG. 5C, the broadcast image 210 displayed in an area formed of the rectangular areas 201 of 2×2 may be displayed in an area formed of the rectangular areas 201 of 3×3, through a predetermined user operation of the remote control 170.

In this case, for example, each of the bookmark browser 240 and the RSS reader 245 may be reduced in size to change the layout to a layout in which seven app images 220 are allocated along the right side and the bottom of one broadcast image 210 as same as the lifestyle home 200a (cf. FIG. 5A).

Moreover, each of the broadcast images 210 and the app images 220 can be enlarged or reduced in size through more steps by reducing the size of the rectangular areas 201 (for example, dividing the home screen 200 into the rectangular areas 201 of 8×8).

That is, dividing the home screen 200 into smaller units can increase the degree of freedom of the allocation layout of the broadcast images 210 and the app images 220.

Thus, when the broadcast image 210 is allocated to a part of the home screen 200 outputted by the output unit 114, and the control unit 116 accepts an instruction for changing the size of the broadcast image 210, the control unit 116 may further cause the output unit 114 to output the home screen 200 including the broadcast image 210 whose size has been changed in response to the instruction.

Moreover, when the image other than the broadcast image 210 is allocated to a part of the home screen 200 outputted by the output unit 114, and the control unit 116 accepts an instruction for changing the size of the image other than the broadcast image 210, the control unit 116 may further cause the output unit 114 to output the home screen 200 including the image which is other than the broadcast image 210 and whose size has been changed in response to the instruction.

This allows for providing the home screen 200 more suitable for the user, for example.

Moreover, for example, the home screen 200 may be scrolled vertically and horizontally. This allows for increasing the total number of the broadcast images 210 and app images 220 to be allocated to one home screen 200.

Moreover, options for an initial screen are not limited to the three kinds shown in FIG. 12.

For example, “Change by time” may be employed as an option. By “Change by time”, the home screen 200 to be selected as an initial screen is changed according to the time when the television 100 is turned on.

FIG. 19 illustrates a basic functional configuration of the television 100 having a function to change the home screen 200 to be displayed as the initial screen according to the time.

The broadcast image output device 110 shown in FIG. 19 includes a confirmation unit 119 for confirming time. The control unit 116 selects one of the home screens 200 according to the time confirmed by the confirmation unit 119, to cause the output unit 114 to output the selected home screen 200.

That is, when the setting information 120 indicates “Change by time”, the broadcast image output device 110 selects and outputs the home screen 200 according to time when the television 100 is turned on.

For example, when 24 hours is divided into three time zones of the morning, afternoon, and night, the broadcast image output device 110 selects and outputs the home screen 200 according to the time zone of the time when the television 100 is turned on.

It should be noted that associations between time zones and the home screens 200 may be preset when the televisions 100 are delivered from a factory, or may be set by users. Moreover, the associations may be included in the setting information 120.

Moreover, in the above embodiment, various information and data such as the setting information 120 which are referred to and processed by the broadcast image output device 110 are stored in the memory unit 117. However, the various information and data may be, for example, obtained from an external device via the Internet or the like.

For example, the broadcast image output device 110 may obtain the screen layout information of the home screen 200 from a video recorder connected to the television 100 via a cable or a server accessible via the Internet.

That is, the home screen 200 created by another device may be added as the home screen 200 which can be outputted by the broadcast image output device 110.

Moreover, the app images 220 allocated to the home screen 200 and the apps associated with the app images 220 do not have to be held in the television 100 all the time.

For example, when the broadcast image output device 110 outputs the home screen 200, the app images 220 and apps associated with the home screen 200 may be obtained from a server accessible via the Internet.

Moreover, after the broadcast image output device 110 is turned on and before the home screen 200 is outputted as an initial screen, the broadcast image output device 110 in the embodiment may, for example, output an image other than the home screen 200, such as a logo indicating the maker of the television 100.

Moreover, the broadcast image output device 110 in the present embodiment may select the home screen 200 to be outputted as the initial screen, based on a physical feature other than user's face.

For example, the identification unit 118 (cf. FIG. 17) obtains feature information indicating a physical feature such as the voice, fingerprint, or vein of the user, and identifies the user in accordance with the obtained feature information.

Thus, the embodiments are described as examples of the art in the present disclosure. Therefore, the appended drawings and detailed explanation are provided.

Therefore, the structural elements recited in the appended drawings and the detailed explanation may include not only structural elements necessary for the solution but also structural elements inessential for the solution. Therefore, the inessential structural elements should not be immediately regarded as essential structural elements only because the appended drawings and the detailed explanation recite these inessential elements.

Moreover, the above embodiments are provided to exemplify the art in the present disclosure. Therefore, various changes, replacements, additions, deletions, and so on are possible within the scope of Claims or the equivalents.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure is applicable to broadcast image output devices which can efficiently perform processing relating to the display of an initial screen suitable for a user. Specifically, the present disclosure is applicable to electronic equipment such as TVs, PCs, servers, portable terminals, video cameras, and video recorders. Moreover, the present disclosure is applicable to recording media such as CDs or DVDs which store programs capable of executing similar functions.

1. A broadcast image output device comprising:
a reception unit configured to receive a broadcast; and
an output unit configured to output a home screen which displays a broadcast image in at least one display area of a plurality of display areas and an image other than the broadcast image in at least another display area of the plurality of display areas, the plurality of display areas each being enclosed by a background image settable and changeable by a user, the broadcast image being selectable by a user operation and related to the broadcast received by the reception unit,
wherein the output unit is further configured to output a home switching screen which at least partially displays each of at least two home screens of a plurality of home screens.

2. The broadcast image output device according to claim 1,
wherein the output unit is configured to output the home switching screen which at least partially displays a reduced image of each of the at least two home screens.

3. The broadcast image output device according to claim 1, further comprising
a control unit configured, when a specification for one home screen selected from the at least two home screens is received as a home switching instruction while the output unit is outputting the home switching screen, to cause the output unit to output the one home screen specified, in accordance with the home switching instruction.

4. The broadcast image output device according to claim 3,
wherein the output unit is further configured to output the home switching screen which displays, side by side, at least one home screen of the plurality of the home screens and an image for adding a new home screen,
the control unit is further configured, when a specification for the image for adding the new home screen is received while the output unit is outputting the home switching screen, to cause the output unit to output a template selection screen, and
the template selection screen displays a plurality of templates, and allows the user to select a template for creating the new home screen, from among the plurality of templates.

5. A television comprising:
a tuner which receives a broadcast;
a display capable of displaying a broadcast image related to the broadcast received by the tuner; and
a processor for controlling display by the display,
wherein the display displays a home screen which displays a broadcast image in at least one display area of a plurality of display areas and an image other than the broadcast image in at least another display area of the plurality of display areas, the plurality of display areas each being enclosed by a background image settable and changeable by a user, the broadcast image being selectable by a user operation and related to the broadcast received by the reception unit, and
the processor causes the display to display a home switching screen which at least partially displays each of at least two home screens of a plurality of home screens.

6. A broadcast image output method comprising:
receiving a broadcast;
outputting a home screen which displays a broadcast image in at least one display area of a plurality of display areas and an image other than the broadcast image in at least another display area of the plurality of display areas, the plurality of display areas each being enclosed by a background image settable and changeable by a user, the broadcast image being selectable by a user operation and related to the broadcast received by the reception unit; and
further outputting a home switching screen which at least partially displays each of at least two home screens of a plurality of home screens.
